(19) United States
(12) Patent Application Publication
(10) Pub. No.: US 2011/0134048 A1
(43) Pub. Date: Jun. 9, 2011

(54) System for Interpretation of Gesture on a Non-All-Points-Addressable Multi-Touch Input Device Having Integrated Buttons

(76) Inventors: Erin K. Walline, Pflugerville, TX (US); Robert C. Nerhood, II, Round Rock, TX (US)

(21) Appl. No.: 12/634,111

(22) Filed: Dec. 9, 2009

(51) Int. Cl. G06F 3/041

(52) U.S. Cl. 345/173

(57) ABSTRACT

A system for interpretation of gesture on a non-all-points-addressable multi-touch input device having integrated buttons. The system for interpretation of gesture on a non-all-points-addressable multi-touch input device having integrated buttons implements a time based method of disregard of a certain button input for a predefined period of time if a user has not actuated the button for a predefined period of time. In certain embodiments, the system detects that a user has had a finger resting on the left button area but has not actuated the left button. If a finger is actively detected performing cursor movement, then another finger is placed on top of the certain button area (i.e., a resting finger), the system can choose to ignore the resting finger with an assumption that the user intends to navigate with the cursor and rest the other finger based on the action and surface area of the second finger (i.e., the other finger).

### BACKGROUND OF THE INVENTION

1. Field of the Invention

The present invention relates to the field of information handling systems and more particularly to input gestures used with information handling systems.

2. Description of Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to present information on a display device of the information handling system. It is also known to provide an information handling system, especially a portable information handling system, with a non-all-points-addressable (APA) touchpad input device with integrated buttons. With such a touchpad input device, some issues can occur when a user rests a finger on top of a certain button area (e.g., the left button area for a touchpad which includes a primary right button orientation).

It has been discovered that touchpad users tend to be one handed users or two handed users. Two handed users typically point (e.g., provide cursor control) with one hand and use to other hand to click a button when desired. Two handed users do not usually have issues with known non-APA touchpad input device designs. One handed users typically rest a thumb on top of the touchpad button while another finger is pointing (e.g., performing cursor control). This function tends to work okay with a touchpad design which includes independent buttons located south of the touchpad. However, in a design where the buttons are integrated into the touchpad (e.g., into the bottom left and bottom right corners of the touchpad), certain issues may be present. For example, if multi-touch gestures are enabled, a second figure point movement can be interpreted as a zoom or rotate gesture. Also, if multi-touch gestures are disabled, the second finger is often ignored. Neither of these scenarios are desirable outcomes.

It has been discovered that users adapt their behavior to accommodate for the inability to have a resting thumb. Accordingly, it would be desirable to provide users with a touchpad input devices which does not require or generally cause users to adjust their behavior.

### SUMMARY OF THE INVENTION

In accordance with the present invention, a system for interpretation of gesture on a non-all-points-addressable multi-touch input device having integrated buttons is disclosed. More specifically, the system for interpretation of gesture on a non-all-points-addressable multi-touch input device having integrated buttons implements a time based method of disregard of a certain button input for a predefined period of time if a user has not actuated the button for a predefined period of time. In certain embodiments, the system detects that a user has had a finger resting on the left button area but has not actuated the left button. If a finger is actively detected performing cursor movement, then another finger is placed on top of the certain button area (i.e., a resting finger), the system can choose to ignore the resting figure with an assumption that the user intends to navigate with the cursor and rest the other figure based on the action and surface area of the second finger (i.e., the other finger).

In certain embodiments, the system limits the size of the available pointing area (making the available pointing area smaller than the overall area of the touchpad) based on where the resting finger is located. However, the smaller available point area is an acceptable tradeoff for the cases where a user has a resting finger which is not all the time and not for everyone because general usage behaviors differ.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows block diagram of an information handling system having a system for interpretation of gesture on a non-all-points-addressable multi-touch input device having integrated buttons.

FIG. 2 shows a plan view of an example information handling system having a non-all-points-addressable multi-touch input device having integrated buttons.

FIG. 3 shows a flowchart of the operation of the system for interpretation of gesture on a non-all-points-addressable multi-touch input device having integrated buttons.

FIG. 4 shows a diagrammatic representation of a touchpad for use with a system for interpretation of gesture on a non-all-points-addressable multi-touch input device having integrated buttons.

FIG. 5 shows a diagrammatic representation of a touchpad for use with a system for interpretation of gesture on a non-all-points-addressable multi-touch input device having integrated buttons.

### DETAILED DESCRIPTION

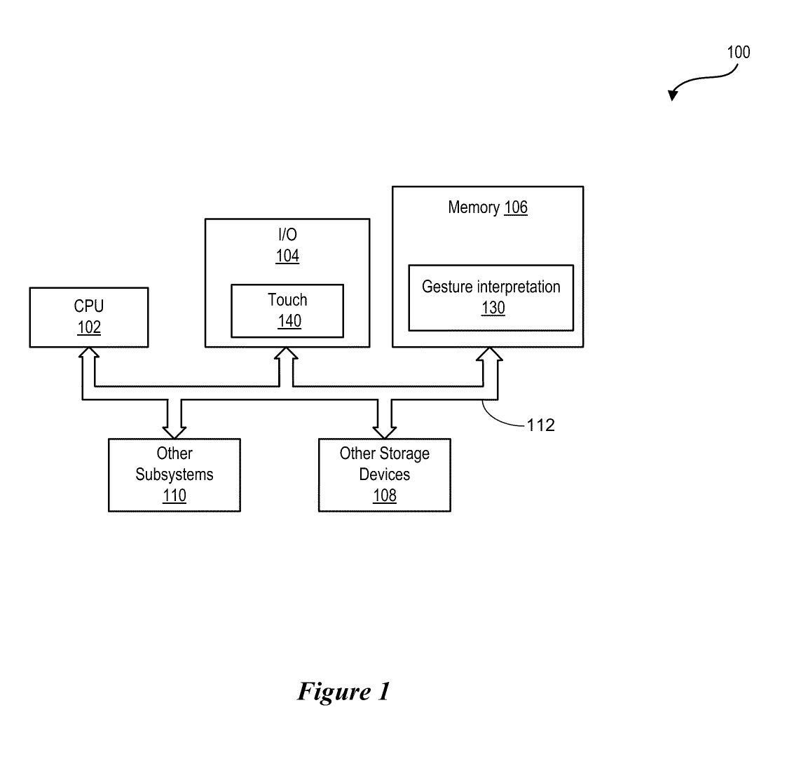

Referring to FIG. 1, a system block diagram of an information handling system 100 such as target information handling system 120 is shown. The information handling system 100 includes a processor 102, input/output (I/O) devices 104, such as a display, a keyboard, a mouse, and associated controllers, memory 206 including non-volatile memory such as a hard disk drive and volatile memory such as random access memory, and other storage devices 108, such as a floppy disk and drive and other memory devices, and various other subsystems 110, all interconnected via one or more buses, shown collectively as bus 112.

The memory stores a system for interpretation of gesture on a non-all-points-addressable multi-touch input device having integrated buttons 130 which includes instructions which are executed by the processor 102 to cause the information handling system to function in a prescribed manner. The I/O devices further include a non-all-points-addressable multi-touch input device having integrated buttons 140.

The system 140 for interpretation of gesture on a non-all-points-addressable multi-touch input device having integrated buttons 140 implements a time based method of disregard of a certain button input for a predefined period of time if a user has not actuated the button for a predefined period of time. In certain embodiments, the system 140 detects that a user has had a finger resting on the left button area but has not actuated the left button. If a finger is actively detected performing cursor movement, then another finger is placed on top of the certain button area (i.e., a resting finger), the system can choose to ignore the resting figure with an assumption that the user intends to navigate with the cursor and rest the other figure based on the action and surface area of the second finger (i.e., the other finger).

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

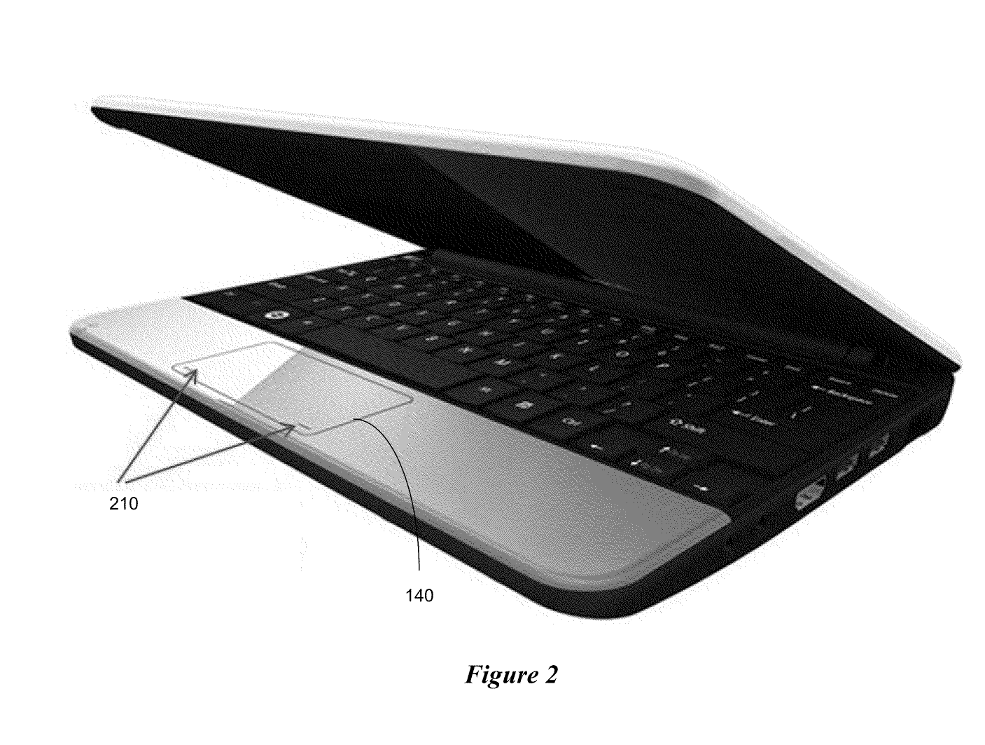

Referring to FIG. 2, a plan view of an example information handling system having a non-all-points-addressable multi-touch input device having integrated buttons is shown. More specifically, the example information handling system 100 includes the non-all-points-addressable multi-touch input device 140 having integrated buttons 210. In certain embodiments, the buttons are located at the bottom left and bottom right of the touchpad 140. The button locations include button location indicia. Each button location indicia can include one or more of a printed mark, a concave dimple or a convex nib.

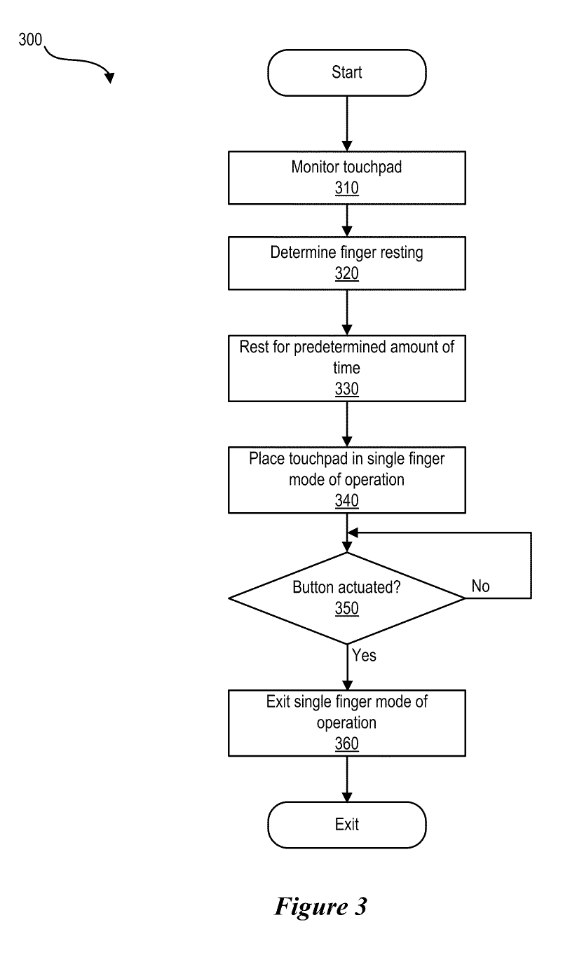

FIG. 3 shows a flowchart of the operation of the system for interpretation of gesture on a non-all-points-addressable multi-touch input device having integrated buttons. More specifically, the system monitors input actions on the touchpad at step 310. Next, the system determines whether a finger is resting on a certain button area at step 320. Next, at step 330, the system determines whether the resting finger has rested while not being actuated for a predefined period of time. Next, at step 340 the system places the touchpad in a single finger mode of operation based upon the determination. Next, the system monitors the touchpad to determine whether the button is actuated at step 350. If the button is not actuated, then the system continues to monitor the touchpad. If the button is actuated, then the system exits the single finger mode of operation at step 360.

If a finger is actively detected performing cursor movement, then another finger is placed on top of the certain button area (i.e., a resting finger), the system can choose to ignore the resting figure with an assumption that the user intends to navigate with the cursor and rest the other figure based on the action and surface area of the second finger (i.e., the other finger).

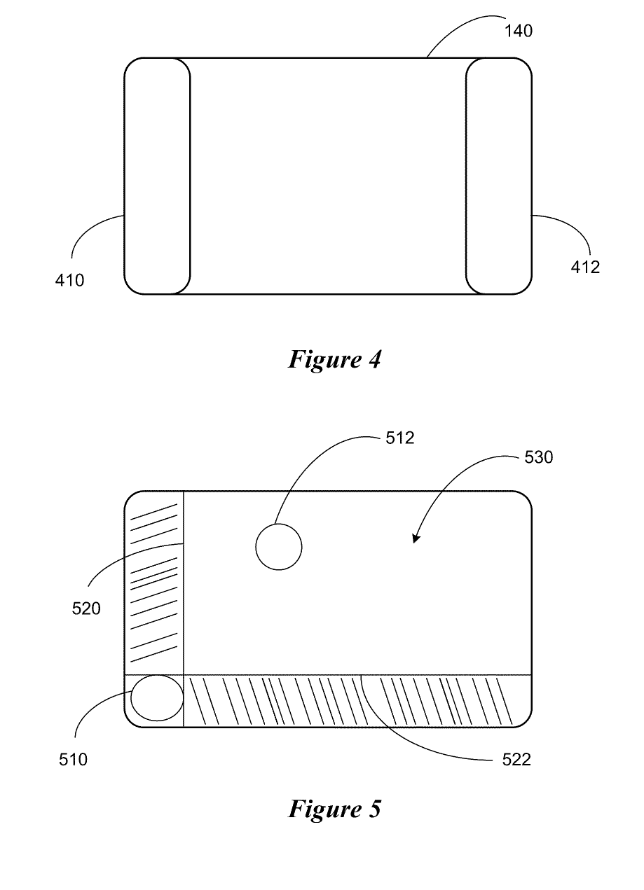

FIG. 4 shows a diagrammatic representation of a touchpad for use with a system for interpretation of gesture on a non-all-points-addressable multi-touch input device having integrated buttons. More specifically, the touchpad 140 includes first and second button portions 410, 412. In certain embodiments, the first and second button portions 410, 412 correspond to left and right side buttons respectively.

FIG. 5 shows a diagrammatic representation of a touchpad for use with a system for interpretation of gesture on a non-all-points-addressable multi-touch input device having integrated buttons. The diagrammatic representation further includes a representation of a resting finger 510 as well as a navigating finger 512. The location of the resting FIG. 510 identifies a resting area (delineated by the lines 520, 522 and identified by diagonal lines). The area of the touchpad located outside of the resting area is the navigable area 530.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, if a finger is actively detected performing cursor movement, then another finger is placed on top of the certain button area (i.e., a resting finger), the system can choose to ignore the resting figure with an assumption that the user intends to navigate with the cursor and rest the other figure based on the action and surface area of the second finger (i.e., the other finger).

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for interpretation of gesture on a multi-touch input device comprising:
monitoring input actions on the multi-touch input device;
determining whether a finger is resting on a certain button area of the multi-touch input device;
determining whether the resting finger has rested while not being actuated for a predefined period of time;
placing the multi-touch input device in a single finger mode of operation based upon the determination; and,
exiting the single finger mode of operation when the certain button is actuated.

2. The method of claim 1 further comprising:
detecting whether a user has had a finger resting on the left button area but has not actuated the certain button.

3. The method of claim 1 wherein:
the certain button is a left button for a primary right button orientation and a right button for a primary left button orientation.

4. The method of claim 1 wherein:
if a finger is actively detected performing cursor movement while another finger is placed on top of the certain button area, then providing an option of ignoring the other figure with an assumption that the user intends to navigate with the cursor and rest the other figure based on the action and surface area of the second finger.

5. The method of claim 1 wherein:
the multi-touch input device comprises a non-all-points addressable multi-touch input device.

6. The method of claim 1 wherein:
the multi-touch input device comprises integrated buttons.

7. An apparatus for interpretation of gesture on a multi-touch input device comprising:
means for monitoring input actions on the multi-touch input device;
means for determining whether a finger is resting on a certain button area of the multi-touch input device;
means for determining whether the resting finger has rested while not being actuated for a predefined period of time;
means for placing the multi-touch input device in a single finger mode of operation based upon the determination; and,
means for exiting the single finger mode of operation when the certain button is actuated.

8. The apparatus of claim 7 further comprising:
means for detecting whether a user has had a finger resting on the left button area but has not actuated the certain button.

9. The apparatus of claim 7 wherein:
the certain button is a left button for a primary right button orientation and a right button for a primary left button orientation.

10. The apparatus of claim 7 wherein:
if a finger is actively detected performing cursor movement while another finger is placed on top of the certain button area, then providing an option of ignoring the other figure with an assumption that the user intends to navigate with the cursor and rest the other figure based on the action and surface area of the second finger.

11. The apparatus of claim 7 wherein:
the multi-touch input device comprises a non-all-points addressable multi-touch input device.

12. The apparatus of claim 7 wherein:
the multi-touch input device comprises integrated buttons.

13. An information handling system comprising:
a processor;
a multi-touch input device coupled to the processor;
a memory coupled to the processor, the memory storing a system for interpretation of gesture on the multi-touch input device, the system comprising instructions executed by the processor for monitoring input actions on the multi-touch input device;
determining whether a finger is resting on a certain button area of the multi-touch input device;
determining whether the resting finger has rested while not being actuated for a predefined period of time;
placing the multi-touch input device in a single finger mode of operation based upon the determination; and,
exiting the single finger mode of operation when the certain button is actuated.

14. The information handling system of claim 13 wherein the system further comprises instruction for:
detecting whether a user has had a finger resting on the left button area but has not actuated the certain button.

15. The information handling system of claim 13 wherein:
the certain button is a left button for a primary right button orientation and a right button for a primary left button orientation.

16. The information handling system of claim 13 wherein:
if a finger is actively detected performing cursor movement while another finger is placed on top of the certain button area, then the system providing an option of ignoring the other figure with an assumption that the user intends to navigate with the cursor and rest the other figure based on the action and surface area of the second finger.

17. The information handling system of claim 13 wherein:
the multi-touch input device comprises a non-all-points addressable multi-touch input device.

18. The information handling system of claim 13 wherein:
the multi-touch input device comprises integrated buttons.
